(19) United States
(12) Patent Application Publication
(10) Pub. No.: US 2025/0126121 A1
(43) Pub. Date: Apr. 17, 2025

(54) UNAUTHORIZED ACCESS DETECTION DEVICE, DATA STORE, AND UNAUTHORIZED ACCESS DETECTION METHOD

(71) Applicant: Hitachi Solutions, Ltd., Tokyo (JP)

(72) Inventors: Yuki UEKI, Tokyo (JP); Katsuya Nishijima, Tokyo (JP); Tomohiro Shigemoto, Tokyo (JP)

(73) Assignee: Hitachi Solutions, Ltd., Tokyo (JP)

(21) Appl. No.: 18/823,813

(22) Filed: Sep. 4, 2024

(30) Foreign Application Priority Data
Oct. 17, 2023 (JP) 2023-178750

(51) Int. Cl. H04L 9/40

(52) U.S. Cl. CPC H04L 63/10

(57) ABSTRACT

A network communication acquisition unit acquires network communication from an application. A communication discrimination filter determines whether the network communication is communication to a data store, and determines whether the network communication is communication for uploading a file to the data store when the network communication is communication to the data store. When the network communication is communication for uploading a file to the data store, a suspicious file upload detection filter evaluates whether the file is encrypted and determines whether the network communication is unauthorized access based on a result of the evaluation.

### BACKGROUND OF THE INVENTION

### 1. Field of the Invention

The present invention relates to an unauthorized access detection device, a data store, and an unauthorized access detection method.

### 2. Description of Related Art

In recent years, social dependency on computers and the Internet has been increasing. Along with this, an attack on a computer and network using malware or the like has come to have more serious impacts on the society. In contrast to showoff of a technical skill or a crime for fun of an attacker in the past, the number of attacks for actual profits such as stealing money and personal information has increased.

Examples of malware mainly intended to collect money include ransomware. Such malware encrypts important files of a user, making the files inaccessible, and the perpetrator takes the files as his property and requests the transmission of money in the form of digital currency or the like for a price for recovery. Damage caused by ransomware became noticeable around 2005, and recently the ransomware has become a serious security issue to the extent of being mentioned as a major security threat.

The traditional ransomware takes a local storage as an attack target. However, due to the improvement of the cloud storage technology, the number of organizations that store important files in a cloud storage without storing the files in a local storage is increasing. In view of such a situation, there is a possibility that the attacker group shifts the attack target from the local storage to the cloud storage in order to continue fund procurement in the future. Actually, a plurality of organizations predict that cloud-targeted ransomware will appear in the future.

The most common method of attacking a cloud storage is to attack a file in a local storage, which is synchronized with a file in a cloud storage, by using traditional ransomware. For example, there is ransomware that actively searches for a file system synchronizing with a cloud storage and attempts to encrypt a file thereof. However, such ransomware requires the presence of a file in the local storage, which is synchronized with the cloud storage, in order to achieve its object, and when the storage location of the file is shifted from the local storage to the cloud storage, it is predicted that the attack cannot be carried out.

In view of such a situation, the appearance of ransomware that attacks a file on local storage that is not synchronized with the cloud storage is predicted. Existing antivirus products for monitoring local file access and file writing cannot deal with such ransomware.

PTL 1 discloses a technique of detecting a suspicious file update in an independent data store. PTL 1 discloses repeatedly scanning a file stored in an independent data store, for example, at the time when communication with the data store is detected, so as to determine whether a malicious activity is in progress based on a difference in meta data before and after the file update. In the determination, for example, the entropy of the file and the magic number of the file are treated as meta-information.

### CITATION LIST

### Patent Literature

PTL 1: Japanese Patent Application No. 2019-507825

### SUMMARY OF THE INVENTION

Different from a technique of detecting file encryption in a local storage, the technique disclosed in PTL 1 can detect file encryption in a data store that is not synchronized with a data store including a cloud storage. However, it is possible to determine whether a malicious activity is in progress only after the file is updated. In PTL 1, as a countermeasure, a method of periodically creating a backup of a file is provided, but when the data store is huge, a high holding cost and a high management cost are required to create a backup thereof.

Due to a technical characteristic of checking a difference in the meta-information before and after the update of the file, although the update of the file can be coped with, it is not possible to cope with an attack that implements file encryption in the data store by deleting the file in the data store once and uploading an encrypted file of the deleted file.

Therefore, the invention provides a technique capable of preventing encryption of a file in a data store.

In order to solve the above problems, a representative unauthorized access detection device according to the invention is provided that includes a control unit. The control unit is configured to acquire network communication from an application, determine whether the network communication is communication to a data store, determine whether the network communication is communication for uploading a file to the data store when the network communication is communication to the data store, evaluate whether the file is encrypted when the network communication is communication for uploading the file to the data store, and determine whether the network communication is unauthorized access based on a result of the evaluation.

According to an aspect of the invention, it is possible to prevent encryption of a file of a data store.

Problems, configurations, and effects other than those described above will be clarified by the following description of embodiments.

### BRIEF DESCRIPTION OF THE DRAWINGS

FIG. 1 is a diagram illustrating an example of an overall configuration of an unauthorized access detection system according to a first embodiment;

FIG. 2 is a functional block diagram illustrating an example of a configuration of a local terminal according to the first embodiment;

FIG. 3 is a block diagram illustrating an example of a hardware configuration of a local terminal according to the first embodiment;

FIG. 4 is a diagram illustrating an example of a communication monitoring destination information table used in an unauthorized access detection unit according to the first embodiment;

FIG. 5 is a diagram illustrating an example of a file meta-information table used in the unauthorized access detection unit according to the first embodiment;

FIG. 6 is a diagram illustrating an example of a file header table used in the unauthorized access detection unit according to the first embodiment;

FIG. 7 is a flowchart illustrating an example of an unauthorized access detection process executed by the local terminal according to the first embodiment;

FIG. 8 is a flowchart illustrating an example of a determination process of a suspicious change to file meta-information;

FIG. 9 is a flowchart illustrating an example of a backup process of a file to be deleted executed by the local terminal according to the first embodiment;

FIG. 10 is a diagram illustrating an example of a warning screen output by the unauthorized access detection unit according to the first embodiment;

FIG. 11 is a diagram illustrating an example of an overall configuration of an unauthorized access detection system according to a second embodiment; and

FIG. 12 is a diagram illustrating an example of an overall configuration of an unauthorized access detection system according to a third embodiment.

### DESCRIPTION OF EMBODIMENTS

Hereinafter, embodiments of the invention will be described in detail with reference to the drawings. In the embodiments, the same components are denoted by the same reference signs in principle, and a repeated description thereof is omitted. It should be noted that the embodiment is merely an example for implementing the invention and does not limit the technical scope of the invention.

### First Embodiment

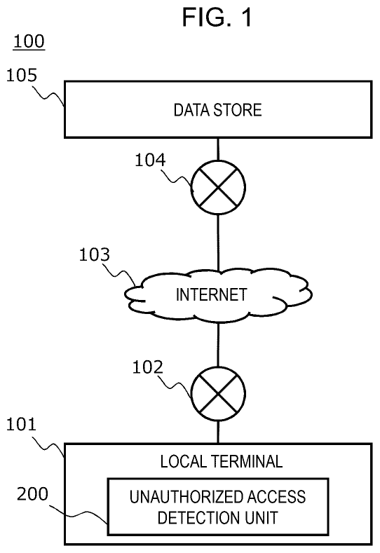

Hereinafter, a first embodiment will be described with reference to FIGS. 1 to 10.

The embodiment relates to a technique of acquiring network communication from an application, determining whether the network communication is communication to a data store, determining whether the network communication is communication to upload a file to the data store when the network communication is communication to the data store, evaluating whether the file is encrypted when the network communication is communication to upload a file to the data store, and determining whether the network communication is unauthorized access based on a result of the evaluation.

In the embodiment, the unauthorized access refers to access to attempt to encrypt a file in a data store by updating or adding a file in the data store by uploading an encrypted file.

Information sharing in the following embodiments will be described using an example in which a computer executes software to realize the function, and may be performed using a hardware logic.

FIG. 1 is a diagram illustrating an example of an overall configuration of an unauthorized access detection system according to the first embodiment.

As illustrated in FIG. 1, an unauthorized access detection system 100 includes a local terminal 101 and a data store 105. The local terminal 101 and the data store 105 are connected to the Internet 103 via networks 102 and 104, respectively.

The networks 102 and 104 may be, for example, a wired local area network (LAN), a wireless LAN, or a global network. The Internet 103 is a type of global network that relays communication performed between the local terminal 101 and the data store 105, and any communication method may be used.

The data store 105 receives a file operation request or a data store setting update request through communication from the local terminal 101, and transmits a result of the file operation or a data store setting update result to the local terminal 101. The local terminal 101 includes an unauthorized access detection unit 200 that detects unauthorized access from the local terminal 101 to the data store 105.

Although the unauthorized access detection system includes the local terminal 101 and the data store 105 in FIG. 1, another device may relay the communication, the local terminal 101 may be connected to another data store, or the data store 105 may be connected to another local terminal. It is sufficient that the unauthorized access detection system includes at least one local terminal and at least one data store.

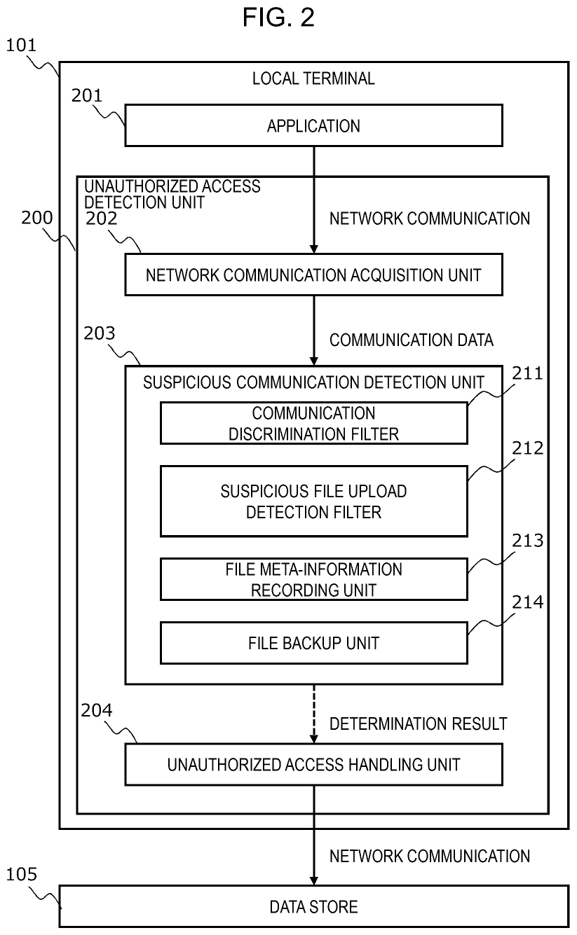

FIG. 2 is a functional block diagram illustrating an example of a configuration of the local terminal 101 according to the first embodiment.

The local terminal 101 according to the first embodiment includes an application 201 and the unauthorized access detection unit 200. The unauthorized access detection unit 200 includes a network communication acquisition unit 202, a suspicious communication detection unit 203, and an unauthorized access handling unit 204.

When the application 201 attempts to perform network communication with the data store 105, the network communication acquisition unit 202 intercepts communication data transmitted from the application 201. The intercepted communication data is transferred to the suspicious communication detection unit 203.

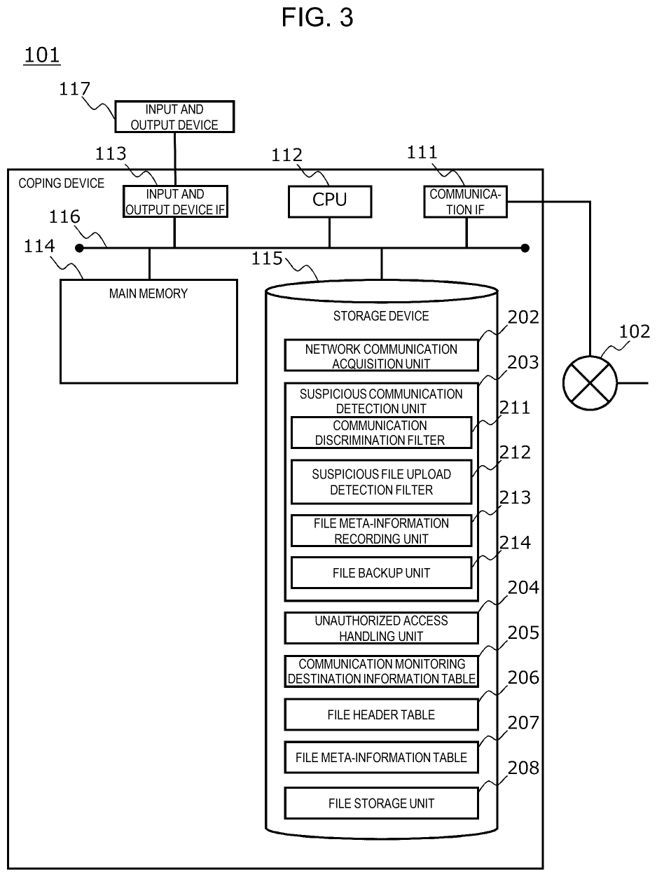

The suspicious communication detection unit 203 includes a communication discrimination filter 211, a suspicious file upload detection filter 212, a file meta-information recording unit 213, and a file backup unit 214, and determines whether the communication data transmitted from the application 201 is an encrypted file. Details of each unit in the suspicious communication detection unit 203 will be described later with reference to FIG. 3.

A determination result of the suspicious communication detection unit 203 is transmitted to the unauthorized access handling unit 204. When the determination result indicates a high possibility that the communication data transmitted from the application 201 is an encrypted file, the unauthorized access handling unit 204 blocks the transmission of the communication data performed by the application 201, warns a user of blocked communication information, and transmits the communication information to the outside. The unauthorized access handling unit 204 may execute all of the three processes, or may execute one or two of the three processes. When the determination result indicates a low possibility that the communication data transmitted from the application 201 is an encrypted file, the communication data transmitted from the application 201 is transmitted to the data store 105.

FIG. 3 is a block diagram illustrating an example of a hardware configuration of the local terminal 101 according to the first embodiment.

The local terminal 101 is implemented by a general information processing device such as a PC shown in FIG. 1, and includes a communication interface (IF) 111, a central processing unit (CPU) 112, an input and output interface (IF) 113, a main memory 114, a storage device 115, and a communication channel 116 connecting these units.

The communication IF 111 is connected to the network 102. The network 102 may be, for example, a wired local area network (LAN) or a wireless LAN, or may be a global network such as the Internet.

The CPU 112 executes a program stored in the storage device 115 and controls each unit of the local terminal 101.

The input and output IF 113 is connected to an input and output device 117 for performing input and output, such as a keyboard, a display, or the like, and mediates input and output of data.

The main memory 114 is a semiconductor storage device such as a random access memory (RAM), and temporarily stores a program loaded from the storage device 115 to be executed by the CPU 112 and necessary work data.

The storage device 115 is, for example, a large-capacity magnetic storage device such as a hard disk drive (HDD) or a semiconductor storage device such as a solid state drive (SSD), and records a program to be executed by the CPU 112 and data used by the CPU 112.

The storage device 115 stores the unauthorized access detection unit 200, a communication monitoring destination information table 205, a file header table 206, a file meta-information table 207, and a file storage unit 208. The unauthorized access detection unit 200 includes programs of the network communication acquisition unit 202, the suspicious communication detection unit 203, and the unauthorized access handling unit 204.

The network communication acquisition unit 202 is a program for acquiring network communication transmitted from the application 201. The network communication may be acquired by a local proxy or may be acquired by filtering communication in a kernel mode.

The suspicious communication detection unit 203 stores the communication discrimination filter 211, the suspicious file upload detection filter 212, the file meta-information recording unit 213, and the file backup unit 214. The suspicious communication detection unit 203 is a program for evaluating, by a method described later, whether communication for accessing the data store 105 is unauthorized access by using network communication collected by the network communication acquisition unit 202.

The unauthorized access handling unit 204 is a program for blocking the network communication determined as unauthorized access by the suspicious communication detection unit 203, notifying the user of blocked communication information, and transmits the blocked network communication information to the outside.

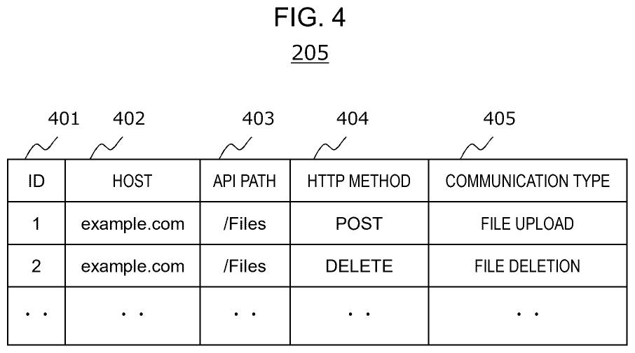

The communication monitoring destination information table 205 is used when the suspicious communication detection unit 203 discriminates network communication to be detected. Details of the communication monitoring destination information table 205 will be described later with reference to FIG. 4.

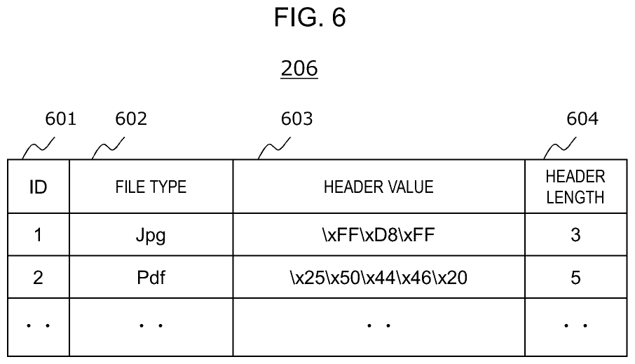

The file header table 206 is used in evaluation of a file header transmitted through network communication in the suspicious communication detection unit 203. Details of the file header table 206 will be described later with reference to FIG. 6.

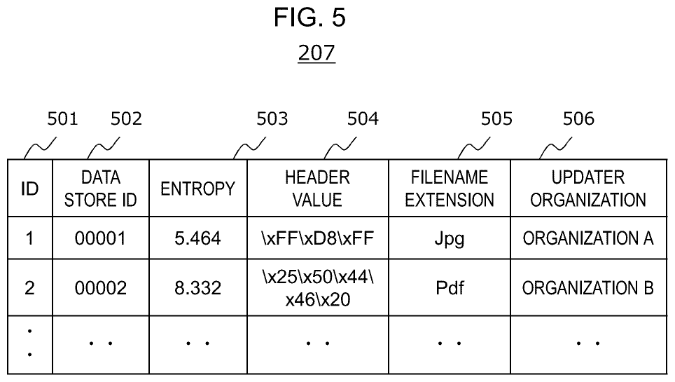

The file meta-information table 207 is used to evaluate file meta-information transmitted through the network communication in the suspicious communication detection unit 203 and to record the file meta-information. Details of the file meta-information table 207 will be described later with reference to FIG. 5.

The file storage unit 208 is a program for storing a file to be deleted as a backup when a request to delete the file in the data store 105 is transmitted through network communication.

The communication channel 116 is an information transmission medium such as a bus or a cable.

The programs and data stored in the storage device 115 may be held in another storage device such as an external storage device of the local terminal 101.

FIG. 4 is a diagram illustrating an example of the communication monitoring destination information table 205 used in the unauthorized access detection unit 200 according to the first embodiment.

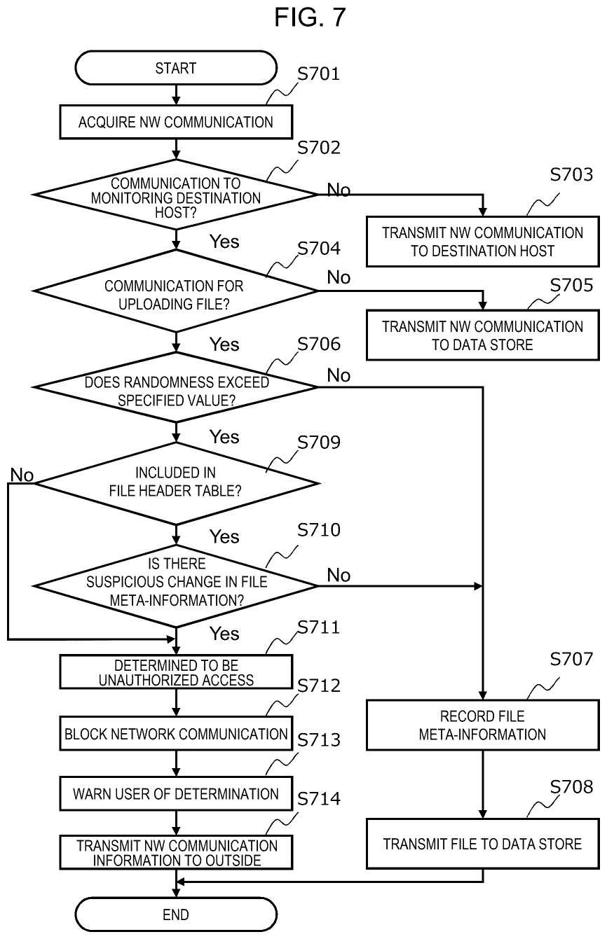

The communication monitoring destination information table 205 stores information used for discriminating whether the network communication acquired by the network communication acquisition unit 202 is the network communication to be monitored. The information is used in the communication discrimination filter 211 included in the suspicious communication detection unit 203. Details of the process using the communication monitoring destination information table 205 will be described later with reference to FIG. 7.

Entries of communication monitoring destination the information table 205 include fields of an ID 401, a host 402, an API path 403, an HTTP method 404, and a communication type 405.

The ID 401 stores an identifier for uniquely identifying one piece of data corresponding to a record of the communication monitoring destination information table 205.

The host 402 stores host information for determining whether the acquired network communication is to be monitored, using a destination host of the network communication acquired by the network communication acquisition unit 202.

The API path 403 stores API path information for determining whether the acquired network communication is to be monitored, using an API path of the network communication acquired by the network communication acquisition unit 202.

The HTTP method 404 stores HTTP method information for determining whether the acquired network communication is to be monitored, using an HTTP method of the network communication acquired by the network communication acquisition unit 202.

The communication type 405 indicates the influence of network communication satisfying all of the host 402, the API path 403, and the HTTP method 404 on data storage.

Referring to FIG. 4 as an example, when the field of the ID 401 has a value of 1, the destination host of the network communication is example.com, the API path is/FILES, and the HTTP method is POST, the network communication is communication for uploading a file to the data store 105.

The communication monitoring destination information table 205 illustrated in FIG. 4 is an example, and may not include some fields or may include another type of information for discriminating whether the network communication acquired by the network communication acquisition unit 202 is to be monitored.

FIG. 5 is a diagram illustrating an example of the file meta-information table 207 used in the unauthorized access detection unit 200 according to the first embodiment.

The file meta-information table 207 stores information used for determining whether the network communication acquired by the network communication acquisition unit 202 is unauthorized access. The information is used by the suspicious file upload detection filter 212 included in the suspicious communication detection unit 203. The file meta-information table 207 is written in the file meta-information recording unit 213. Details of the process using the file meta-information table 207 will be described later with reference to FIG. 7.

Entries of the file meta-information table 207 include fields of an ID 501, a data store ID 502, an entropy 503, a header value 504, a filename extension 505, and an updater organization 506.

The ID 501 stores an identifier for uniquely identifying one piece of data corresponding to a record of the file meta-information table 207.

The data store ID 502 stores an identifier for uniquely identifying a file by the data store 105 when a file uploaded by network communication is to be managed on the data store 105.

The entropy 503 stores an entropy value of a file identified by the data store ID 502.

The header value 504 stores a header value of the file identified by the data store ID 502. A length of the header value to be stored may be a constant, or only a header value included in a table indicating known file header information may be acquired. A field for recording the length of the acquired file header may be provided in the entry of the file meta-information table 207.

The filename extension 505 stores a filename extension of a file identified by the data store ID 502.

The updater organization 506 stores organization information of an updater who attempts to update the data store 105, which is acquired from the data store 105 using the network communication acquired by the network communication acquisition unit 202 or using information included in the network communication.

The file meta-information table 207 illustrated in FIG. 5 is an example, and may not include some fields or may include fields for storing other types of file meta-information.

FIG. 6 is a diagram illustrating an example of the file header table 206 used in the unauthorized access detection unit 200 according to the first embodiment.

The file header table 206 stores header information of a file type for which a high value is calculated even in a normal state when randomness of a file is calculated. The information is used by the suspicious file upload detection filter 212 included in the suspicious communication detection unit 203.

Details of process using the file header table 206 will be described later with reference to FIG. 7.

Entries of the file header table 206 includes fields of an ID 601, a file type 602, a header value 603, and a header length 604.

The ID 601 stores an identifier for uniquely identifying one piece of data corresponding to a record of the file header table 206.

The file type 602 stores a name of a file type.

The header value 603 stores a header value used for identifying a file header.

The header length 604 stores a length of the header value 603.

The file header table 206 illustrated in FIG. 6 is an example, and may not include some fields or may include fields for storing other types of file header information.

Next, a process of detecting communication for overwriting a file in the data store 105 with an encrypted file will be described with reference to FIG. 7.

FIG. 7 is a flowchart illustrating an example of an unauthorized access detection process executed by the local terminal 101 according to the first embodiment.

First, when network communication is transmitted from the application 201, the network communication is acquired by the network communication acquisition unit 202 (S701).

Next, it is determined whether the acquired network communication is communication to a monitoring destination host by determining whether a destination host of the acquired network communication has a value equal to any of the entries of the host 402 included in the communication monitoring destination information table 205 in FIG. 4 (S702).

In S702, if the destination host of the network communication has a value different from all entries of the host 402 included in the communication monitoring destination information table 205, it is determined that the acquired network communication is not communication to the monitoring destination host (NO in S702), the network communication is transmitted to the destination host (S703), and the process ends.

On the other hand, in S702, if the destination host of the network communication has a value equal to any of the entries of the host 402 included in the communication monitoring destination information table 205, it is determined that the acquired network communication is communication to the monitoring destination host (YES in S702), and the process proceeds to S704.

In S704, a communication type is obtained by comparing the host 402, the API path 403, and the HTTP method 404 included in the communication monitoring destination information table 205 in FIG. 4 with the destination host, the API path, and the HTTP method of the acquired network communication, and it is determined whether the acquired network communication is communication related to file upload.

If the acquired network communication is not communication related to file upload in S704 (No in S704), the network communication is transmitted to the data store 105 (S705), and the process ends.

On the other hand, if the acquired network communication is communication related to file upload in S704 (Yes in S704), the process proceeds to S706 to determine whether the network communication is unauthorized access. The processes of S702 to S705 are performed by the communication discrimination filter 211 included in the suspicious communication detection unit 203.

In the processes of S706 and S709 to S711, file information transmitted is acquired from the acquired network communication, and it is determined whether the acquired network communication is unauthorized access by analyzing the file information. The processes of S706 and S709 to S711 are performed by the suspicious file upload detection filter 212 included in the suspicious communication detection unit 203.

In S706, randomness is obtained from the entropy of the file, and it is determined whether the obtained value exceeds a specified value. In this evaluation, when a file is encrypted, a characteristic that the randomness is higher than that of a normal file is used. The information of the file may be evaluated using a method other than the method of calculating the entropy. For example, the randomness may be evaluated using a method using template matching for obtaining an existence probability of a specific bit pattern or a method using statistics of the probability that the same character is included in a character string having a fixed length.

The specified value may be a fixed value regardless of the file type, or may be determined for each file type. For example, since it is known that an image file or an encrypted ZIP file has high randomness even in a normal state, a high specified value may be provided for the file. A model may be created by learning the randomness in normal times using machine learning or the like, and the specified value may be determined using the created model.

Regarding a length of file data used for calculating the randomness, the entire file or a part of the file may be used. For example, among ransomware that performs encryption, there is ransomware that performs encryption only at the head of a file and malware that adds an encryption key encoded by Base64 to the end of a file. For a file encrypted by such ransomware, if the randomness of the entire file is evaluated, the randomness that is not different from that of a normal file may be calculated. Accordingly, it may be determined whether the file is encrypted by evaluating the randomness of a part of the head of the file.

If it is determined in S706 that the randomness of the file is equal to or less than the specified value (No in S706), it is determined that the network communication is not unauthorized access, and the process proceeds to S707.

In the process of S707, file meta-information of the file to be uploaded to the data store 105 is recorded in the file meta-information table 207 in FIG. 5 by the file meta-information recording unit 213. In the unauthorized access detection unit 200 according to the first embodiment, the recorded file meta-information includes the data store ID 502, the entropy 503, the header value 504, the filename extension 505, and the updater organization 506. The information is extracted from network communication information and recorded in the file meta-information table 207 by the file meta-information recording unit 213. Thereafter, the file is transmitted to the data store 105 (S708), and the process ends.

On the other hand, if it is determined in S706 that the randomness of the file exceeds the specified value (Yes in S706), it is determined that the network communication is highly likely to be unauthorized access, and the process proceeds to S709 which is a next detection process.

In S709, it is determined whether a header of the file uploaded through the network communication is included in the file header table 206 in FIG. 6. The file header table 206 stores a file header of a file type having a high entropy and high randomness.

Accordingly, if the file header is not included in the file header table 206 in S709 (No in S709), the file header is not a file header of a known file having high randomness despite of the determination that the randomness of the file is high in the process of S706. Therefore, it is determined that the file uploaded by the network communication is highly likely to be an encrypted file, the network communication is determined to be unauthorized access (S711), and the process proceeds to S712 and subsequent steps.

On the other hand, if the file header is included in the file header table 206 in S709 (Yes in S709), it is found that the randomness of the file being high is normal. Accordingly, in order to perform the next detection process, the process proceeds to S710.

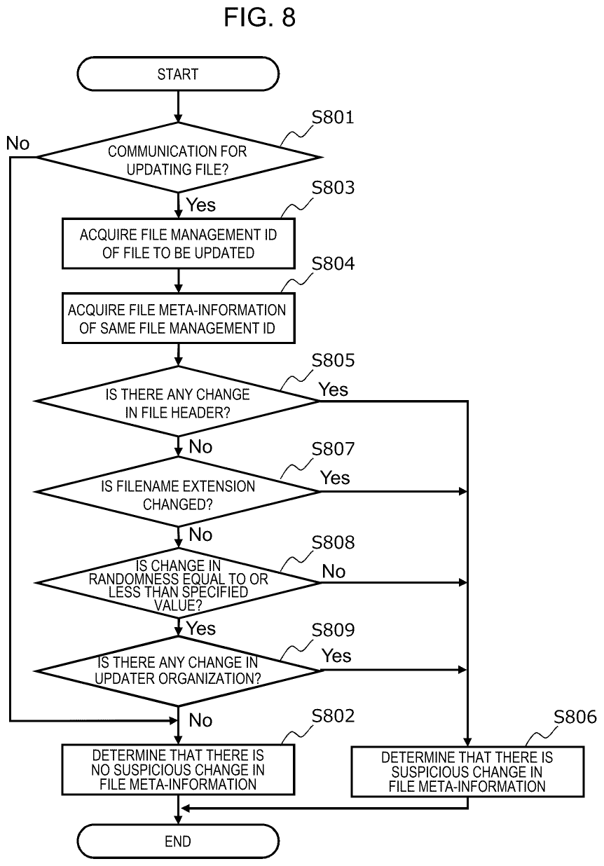

In the process of S710, it is determined whether the network communication is communication for updating a file of the data store 105, and if the network communication is communication for updating a file of the data store 105, it is determined whether there is a suspicious change in the file meta-information of the file to be uploaded to the data store 105 by comparing with the file information included in the file meta-information table 207 in FIG. 5. Details of the process of S710 will be described later with reference to FIG. 8.

If it is determined in S710 that there is no suspicious change in the file meta-information of the file to be uploaded to the data store 105 (No in S710), it is determined that the network communication is not unauthorized access, the file meta-information of the file to be uploaded to the data store 105 is recorded in the file meta-information table 207 by the file meta-information recording unit 213 (S707), the file is transmitted to the data store 105 (S708), and the process ends.

When it is determined in S710 that there is a suspicious change in the file meta-information of the file to be uploaded to the data store 105 (Yes in S710), it is determined that the network communication is unauthorized access (S711), and the process proceeds to S712 and subsequent steps. In the embodiment, although it is determined that the network communication is unauthorized access when the process proceeds to S711, a process of inputting a suspicious degree calculated by another endpoint detection and response (EDR) product or the like and determining whether the network communication is unauthorized access using the input suspicious degree may be added.

In S712, since it is determined that the network communication is unauthorized access, the network communication is blocked.

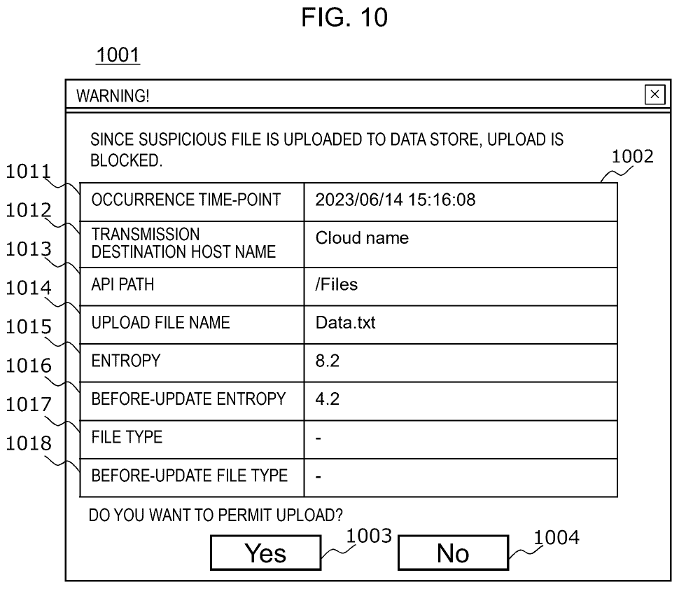

Next, the user is warned that the network communication is determined to be unauthorized access (S713). The information to be warned may include not only the determination result but also the network communication information and a basis of the determination of the unauthorized access. The warning is performed, for example, by displaying a warning screen on the input and output device 117. Details of the warning screen will be described later with reference to FIG. 10.

Next, the blocked network communication information is transmitted to the outside (S714), and the process ends. A transmission destination of the network communication information may be a security management apartment of an organization to which the user belongs, which manages the security of a PC of the user, or may be an external security management organization such as a managed service. The network communication information transmission destination may be an organization that provides the program 4 the unauthorized access detection unit 200 according to the first embodiment.

Regarding a transmission method of the network communication information, the network communication information may be transmitted using an e-mail or a message to a chat tool, or may be transmitted to an external application via an API.

The information to be transmitted may include not only the network communication information but also the basis of the determination of the unauthorized access and the determination result.

The processes of S712 to S714 are performed by the unauthorized access handling unit 204.

Although an example in which the local terminal 101 of the embodiment executes the three processes of S712 to S714 is illustrated, the local terminal 101 may execute one or two of the three processes.

According to the processes in FIG. 7, the communication for overwriting a file in the data store 105 with an encrypted file is detected, the network communication is blocked, the user is warned that the network communication is determined to be unauthorized access, and the blocked network communication information is transmitted to the outside, whereby the encryption of the file in the data store can be prevented.

Next, a process of determining whether there is a suspicious change in the file meta-information of the file to be uploaded to the data store 105 will be described with reference to FIG. 8.

FIG. 8 is a flowchart illustrating an example of a determination process of a suspicious change to the file meta-information in S710 in FIG. 7.

First, the communication type is obtained by comparing the host 402, the API path 403, and the HTTP method 404 included in the communication monitoring destination information table 205 with the destination host, the API path, and the HTTP method of the network communication acquired in S701 in FIG. 7, and it is determined whether the acquired network communication is communication for updating a file in the data store 105 (S801).

If it is determined in S801 that the network communication is not communication for updating a file in the data store 105 (No in S801), since detection cannot be performed in the detection process, it is determined that there is no suspicious change in the file meta-information of the file to be uploaded to the data store 105 (S802), and the process ends.

When it is determined in S801 that the network communication is communication for updating a file in the data store 105 (Yes in S801), a file management ID in the data store 105 of the file to be updated is acquired from the network communication information (S803).

Next, file meta-information having the same file management ID as the file management ID acquired in S803 is acquired from the file meta-information table 207 (S804). The file meta-information table 207 includes file meta-information recorded by the file meta-information recording unit 213 when network communication for file upload to the data store 105 is determined to be normal. Accordingly, it is possible to compare the file meta-information of the same file management ID acquired from the file meta-information table 207 with the meta-information of the file transmitted through the network communication.

Next, it is evaluated whether there is no change in file header between the file meta-information acquired in S804 and the meta-information of the file transmitted through the network communication (S805). If the file header at the head of the file is encrypted by the encryption of the file, the change can be detected by the evaluation. Since a process of changing the file header is not a normal process, if the file header is changed, it can be determined that the file in the data store 105 is illegally changed.

If the file header is changed in S805 (Yes in S805), it is determined that there is a suspicious change in the file meta-information of the file to be uploaded to the data store 105 (S806), and the determination process ends.

On the other hand, if there is no change in the file header in S805 (No in S805), it is evaluated whether a filename extension of the file is not changed between the file meta-information acquired in S804 and the meta-information of the file transmitted through the network communication (S807).

If the filename extension of the file is changed in S807 (Yes in S807), since a change in the filename extension is abnormal even though there is no change in the file header, it is determined that there is a suspicious change in the file meta-information of the file to be uploaded to the data store 105 (S806), and the process ends.

On the other hand, if the filename extension of the file is not changed in S807 (No in S807), it is evaluated whether a change in randomness is equal to or less than the specified value between the file meta-information acquired in S804 and the meta-information of the file transmitted through the network communication (S808). Since the randomness of files of the same file type does not change greatly, it is highly likely that the file is encrypted when there is a great change exceeding the specified value. The specified value may be a fixed value regardless of the file type, or may be determined for each file type. A model may be created by learning the randomness in normal times using machine learning or the like, and the specified value may be determined using the created model.

If the change in the randomness exceeds the specified value in S808 (No in S808), it is determined that there is a suspicious change in the file meta-information of the file to be uploaded to the data store 105 (S806), and the process ends.

On the other hand, if the change in the randomness is equal to or less than the specified value in S808 (Yes in S808), it is determined whether there is no change in the organization of the updater between the file meta-information acquired in S804 and the meta-information of the file transmitted through the network communication (S809). Regarding a file for which a file change performed by a different organization is conceivable, a flag may be set not to perform the process of S808. Further, the process of S808 may be performed only for a specified file.

If there is a change in the updater organization in S809 (Yes in S809), it is determined that there is a suspicious change in the file meta-information of the file to be uploaded to the data store 105 (S806), and the process ends.

On the other hand, if there is no change in the updater organization in S809 (No in S809), it is determined that there is no suspicious change in the file meta-information of the file to be uploaded to the data store 105 (S802), and the process ends.

The detection process of detecting a suspicious change in file meta-information using the file meta-information at the time of uploading a file to the data store 105 illustrated in FIG. 8 is an example, and only one or more of the evaluations in S805 to S809 may be performed, or evaluations other than those above for detecting a suspicious change in the file meta-information may be performed in combination.

There are two methods of encrypting a file in the data store 105. The first method is a method of overwriting a file in the data store 105 with encrypted file data. In this method, it is possible to protect the file in the data store 105 by detecting the upload of the encrypted file and blocking the network communication.

The second method is a method of deleting a file in the data store 105 once and then uploading an encrypted file newly. In this method, even if the upload of the encrypted file is detected and the network communication is blocked, the file cannot be protected if the file in the data store 105 is deleted first.

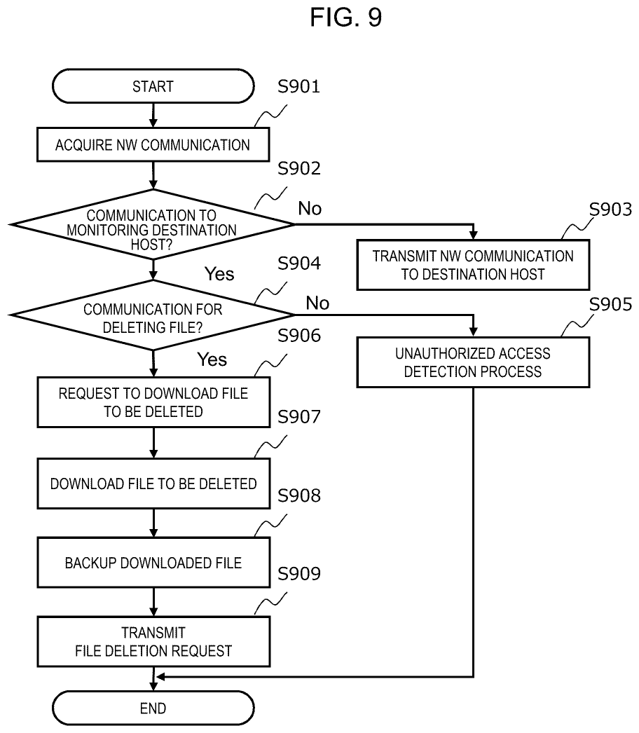

Accordingly, in order to cope with such a case, the unauthorized access detection unit 200 may have a function of backing up and protecting a file to be deleted when communication for deleting a file in the data store 105 is detected. A process of detecting communication for deleting a file in the data store 105 and backing up the file to be deleted will be described with reference to FIG. 9.

FIG. 9 is a flowchart illustrating an example of a backup process of a file to be deleted executed by the local terminal 101 according to the first embodiment.

First, when network communication is transmitted from the application 201, the network communication is acquired by the network communication acquisition unit 202 (S901).

Next, it is determined whether the acquired network communication is communication to a monitoring destination host by determining whether a destination host of the acquired network communication has a value equal to any of the entries of the host 402 included in the communication monitoring destination information table 205 in FIG. 4 (S902).

In S902, if the destination host of the network communication has a value different from all entries of the host 402 included in the communication monitoring destination information table 205, it is determined that the acquired network communication is not communication to the monitoring destination host (No in S902), the network communication is transmitted to the destination host (S903), and the process ends.

On the other hand, in S902, if the destination host of the network communication has a value equal to any of the entries of the host 402 included in the communication monitoring destination information table 205, it is determined that the acquired network communication is communication to the monitoring destination host (Yes in S902), and the process proceeds to S904.

In S904, a communication type is obtained by comparing the host 402, the API path 403, and the HTTP method 404 included in the communication monitoring destination information table 205 in FIG. 4 with the destination host, the API path, and the HTTP method of the acquired network communication, and it is determined whether the acquired network communication is communication related to file deletion.

If the acquired network communication is not communication related to file deletion in S904 (No in S904), the unauthorized access detection process in FIG. 7 is executed (S905), and the process ends.

On the other hand, if the acquired network communication is communication related to file deletion in S904 (Yes in S904), the process proceeds to S906 to back up the file to be deleted. The processes of S902 to S905 are performed by the communication discrimination filter 211 included in the suspicious communication detection unit 203.

Next, the file backup unit 214 included in the suspicious communication detection unit 203 acquires information on the file to be deleted from the acquired network communication, and sends a request of downloading the file to be deleted to the data store 105 using the acquired information (S906).

Next, the data store 105 that acquires the request transmits the requested file to the local terminal 101, and the file backup unit 214 included in the suspicious communication detection unit 203 downloads the transmitted file to be deleted (S907).

Next, the file backup unit 214 included in the suspicious communication detection unit 203 stores the downloaded file in the file storage unit 208 and backs up the file (S908).

Next, the network communication related to the file deletion request is transmitted to the data store 105 (S909), and the process ends. The data store 105 that receives the network communication related to the file deletion request executes file deletion.

According to the processes in FIG. 9, by detecting communication for deleting a file in the data store 105 and backing up the file to be deleted, it is possible to cope with an attack that implements file encryption in the data store by deleting the file in the data store once and uploading an encrypted file of the deleted file.

Next, a warning screen for a user when unauthorized access is detected, which is used in S713 in FIG. 7, will be described with reference to FIG. 10.

FIG. 10 is a diagram illustrating an example of a warning screen output by the unauthorized access detection unit 200 according to the first embodiment.

As illustrated in FIG. 10, a warning screen 1001 includes an analysis result display table 1002. Entries of the analysis result display table 1002 include an occurrence time-point 1011, a transmission destination host name 1012, an API path 1013, an upload file name 1014, an entropy 1015, a before-change entropy 1016, a file type 1017, and a before-change file type 1018.

The occurrence time-point 1011 indicates a time point at which unauthorized access is detected.

The transmission destination host name 1012 indicates a transmission destination host name of network communication transmitted by the application 201.

The API path 1013 indicates an API path of the network communication transmitted by the application 201.

The upload file name 1014 indicates a file name of the file to be uploaded, which is acquired from the network communication transmitted by the application 201.

The entropy 1015 indicates an entropy value calculated by the suspicious file upload detection filter 212 included in the suspicious communication detection unit 203.

The before-change entropy 1016 indicates an entropy value included in the file meta-information acquired in S804 in FIG. 8 in the suspicious file upload detection filter 212 included in the suspicious communication detection unit 203.

The file type 1017 indicates the file type 602 acquired from the file header table 206 in S709 in FIG. 7 in the suspicious file upload detection filter 212 included in the suspicious communication detection unit 203. When the file type 602 cannot be acquired in S709, a filename extension that can be acquired from the file name acquired from the network communication is shown.

The before-change file type 1018 indicates the file type included in the file meta-information acquired in S804 in the suspicious file upload detection filter 212 included in the suspicious communication detection unit 203.

The analysis result display table 1002 may include only some of the entries illustrated in FIG. 10, or may include information related to other analysis results.

An upload permission button 1003 and an upload block button 1004 are buttons for notifying, by a user operation, the local terminal 101 of the determination as to whether to re-execute the blocked upload. For execution of the re-upload, an operation by a suspicious application may be prevented by using multi-element authentication or the like.

According to the first embodiment, the communication for overwriting a file in the data store 105 with an encrypted file is detected, the network communication is blocked, the user is warned that the network communication is determined to be unauthorized access, and the blocked network communication information is transmitted to the outside, whereby the encryption of the file in the data store can be prevented.

By detecting communication for deleting a file in the data store 105 and backing up the file to be deleted, it is possible to cope with an attack that implements file encryption in the data store by deleting the file in the data store once and uploading an encrypted file of the deleted file.

### Second Embodiment

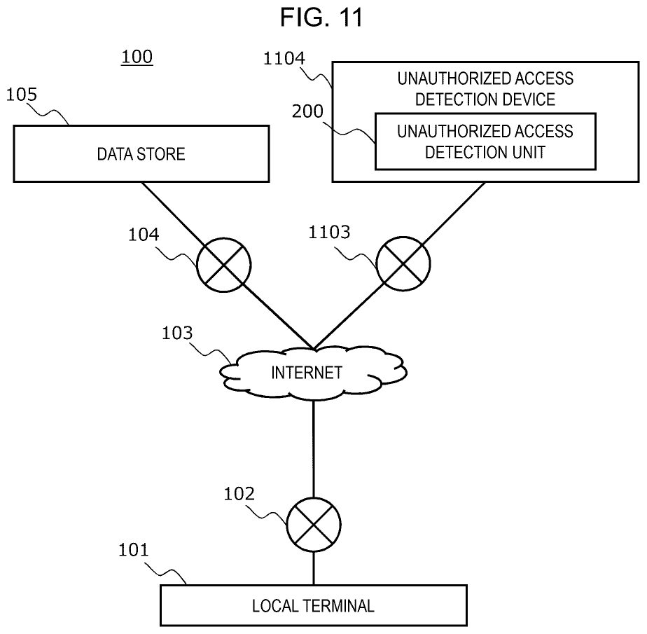

Hereinafter, a second embodiment will be described with reference to FIG. 11.

Although the unauthorized access detection unit 200 according embodiment is installed in the local terminal 101, in the second embodiment, as illustrated in FIG. 11, the unauthorized access detection unit 200 is installed in a device different from the local terminal 101.

FIG. 11 is a diagram illustrating an example of an overall configuration of the unauthorized access detection system 100 according to the second embodiment.

As illustrated in FIG. 11, the unauthorized access detection system 100 includes the local terminal 101, the data store 105, and an unauthorized access detection device 1104. The local terminal 101, the data store 105, and the unauthorized access detection device 1104 are connected to the Internet 103 via networks 102, 104, and 1103, respectively.

The networks 102, 104 and 1103 may be, for example, a wired local area network (LAN), a wireless LAN, or a global network. The Internet 103 is a type of global network that relays communication performed between the local terminal 101 and the data store 105, and any communication method may be used.

The data store 105 receives a file operation request or a data store setting update request through communication from the local terminal 101, and transmits a result of the file operation or a data store setting update result to the local terminal 101. The unauthorized access detection device 1104 includes the unauthorized access detection unit 200 that detects unauthorized access from the local terminal 101 to the data store 105.

The configuration of the unauthorized access detection unit 200 is the same as that of the first embodiment. The unauthorized access detection unit 200 monitors communication between the local terminal 101 and the data store 105, and performs the unauthorized access detection process as illustrated in FIG. 7. When unauthorized access is determined, the network communication is blocked, the user is warned that the network communication is determined to be unauthorized access, and the blocked network communication information is transmitted to the outside.

By performing the backup process as illustrated in FIG. 9, communication for deleting a file in the data store 105 is detected and the file to be deleted is backed up.

By employing the configuration as illustrated in the second embodiment, the user of the unauthorized access detection system 100 does not need to introduce the unauthorized access detection unit 200 to the local terminal 101 of an own organization, and the unauthorized access detection unit 200 can be installed more easily.

### Third Embodiment

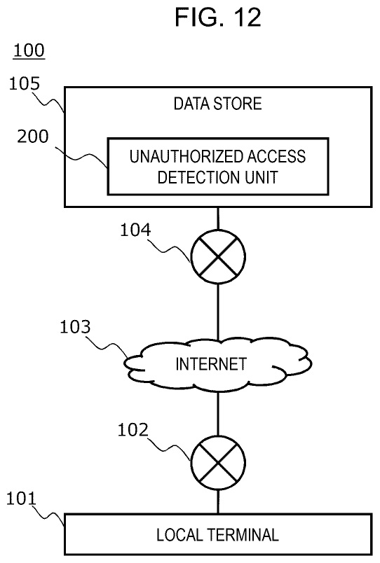

Hereinafter, a third embodiment will be described with reference to FIG. 12.

Although the unauthorized access detection unit 200 according to the first embodiment is installed in the local terminal 101, in the third embodiment, as illustrated in FIG. 12, the unauthorized access detection unit 200 is installed in the data store 105.

FIG. 12 is a diagram illustrating an example of an overall configuration of the unauthorized access detection system 100 according to the third embodiment.

As illustrated in FIG. 12, the unauthorized access detection system 100 includes the local terminal 101 and the data store 105. The local terminal 101 and the data store 105 are connected to the Internet 103 via the networks 102 and 104, respectively.

The networks 102 and 104 may be, for example, a wired local area network (LAN), a wireless LAN, or a global network. The Internet 103 is a type of global network that relays communication performed between the local terminal 101 and the data store 105, and any communication method may be used.

The data store 105 receives a file operation request or a data store setting update request through communication from the local terminal 101, and transmits a result of the file operation or a data store setting update result to the local terminal 101. The data store 105 includes the unauthorized access detection unit 200 that detects unauthorized access from the local terminal 101 to the data store 105.

The configuration of the unauthorized access detection unit 200 is the same as that of the first embodiment. The unauthorized access detection unit 200 monitors communication between the local terminal 101 and the data store 105, and performs the unauthorized access detection process as illustrated in FIG. 7. When unauthorized access is determined, the network communication is blocked, the user is warned that the network communication is determined to be unauthorized access, and the blocked network communication information is transmitted to the outside.

By performing the backup process as illustrated in FIG. 9, communication for deleting a file in the data store 105 is detected and the file to be deleted is backed up.

With the configuration illustrated in the third embodiment, the user of the unauthorized access detection system 100 does not need to perform a procedure of installing the unauthorized access detection unit 200 to the local terminal 101, and unauthorized access detection can be performed in all communication to the data store 105.

What is claimed is:

1. An unauthorized access detection device comprising:
a control unit configured to
acquire network communication from an application,
determine whether the network communication is communication to a data store,
determine whether the network communication is communication for uploading a file to the data store when the network communication is communication to the data store,
evaluate whether the file is encrypted when the network communication is communication for uploading the file to the data store, and
determine whether the network communication is unauthorized access based on a result of the evaluation.

2. The unauthorized access detection device according to claim 1, wherein
when it is determined that the network communication is unauthorized access, the control unit blocks the network communication.

3. The unauthorized access detection device according to claim 1, wherein
when it is determined that the network communication is unauthorized access, the control unit notifies a user of a result of the determination.

4. The unauthorized access detection device according to claim 1, wherein
when it is determined that the network communication is unauthorized access, the control unit transmits a result of the determination to an outside.

5. The unauthorized access detection device according to claim 1, further comprising:
a file storage unit, wherein
the control unit
determines whether the network communication is communication for requesting file deletion of the data store, and
stores, in the file storage unit, the file to be deleted when the network communication is communication for requesting file deletion of the data store.

6. A data store comprising:
a control unit configured to
acquire network communication from an application,
determine whether the network communication is communication for uploading a file,
evaluate whether the file is encrypted when the network communication is communication for uploading the file, and
determine whether the network communication is unauthorized access based on a result of the evaluation.

7. The data store according to claim 6, wherein
when it is determined that the network communication is unauthorized access, the control unit blocks the network communication.

8. The data store according to claim 6, wherein
when it is determined that the network communication is unauthorized access, the control unit notifies a user of a result of the determination.

9. The data store according to claim 6, wherein
when it is determined that the network communication is unauthorized access, the control unit transmits a result of the determination to an outside.

10. The data store according to claim 6, further comprising:
a file storage unit, wherein
the control unit
determines whether the network communication is communication for requesting file deletion of the data store, and
stores, in the file storage unit, the file to be deleted when the network communication is communication for requesting file deletion of the data store.

11. An unauthorized access detection method comprising:
acquiring network communication from an application;
determining whether the network communication is communication to a data store;
determining whether the network communication is communication for uploading a file to the data store when the network communication is communication to the data store;
evaluating whether the file is encrypted when the network communication is communication for uploading the file to the data store; and
determining whether the network communication is unauthorized access based on a result of the evaluation.

12. The unauthorized access detection method according to claim 11, wherein
when it is determined that the network communication is unauthorized access, the network communication is blocked.

13. The unauthorized access detection method according to claim 11, wherein
when it is determined that the network communication is unauthorized access, a result of the determination is notified to a user.

14. The unauthorized access detection method according to claim 11, wherein
when it is determined that the network communication is unauthorized access, a result of the determination is transmitted to an outside.

15. The unauthorized access detection method according to claim 11, wherein
it is determined whether the network communication is communication for requesting file deletion of the data store, and
when the network communication is communication for requesting file deletion of the data store, the file to be deleted is stored in a storage device.
